(19) United States
(12) Patent Application Publication
(10) Pub. No.: US 2024/0159414 A1
(43) Pub. Date: May 16, 2024

(54) METHOD FOR MONITORING AN ENVIRONMENT

(71) Applicant: INTEREL PTE LTD, Singapore (SG)

(72) Inventor: Stefano Francesco Florian GALLINI, Dubai (AE)

(21) Appl. No.: 18/505,837

(22) Filed: Nov. 9, 2023

(30) Foreign Application Priority Data
Nov. 11, 2022 (IT) 102022000023328

(51) Int. Cl. F24F 11/62; H05B 47/115

(52) U.S. Cl. CPC F24F 11/62; H05B 47/115; F24F 2120/10

(57) ABSTRACT

Method for monitoring an environment (A) comprising the steps of emitting, by means of wireless transmission, a presence code indicative of a user in the environment through a transmitter (1) of the environment (A), intercepting the presence code by means of a user interface device (2), detecting an opening and subsequent closing event of an access door (P) of the environment (A), and adjusting an environmental control system (3) if, after the detected event, the presence code is not intercepted by the user interface device (2) after a preset time interval.

### TECHNICAL FIELD

The present invention relates to a method and a system for monitoring an environment.

The term environment is intended as a room, a corridor, a common room, a garden and more in general any environment which is enclosed or in some way delimited by walls or fences.

In particular, the present invention finds application in the hotel sector and more in particular in the field of room air conditioning. For example, the present invention can be applied in the residential sector.

### PRIOR ART

To date, devices are known for detecting the presence of a user inside a room such as, for example, motion sensors.

Generally, from the moment in which the sensors no longer detect the presence of a user, a countdown is initiated, which generally ranges from twenty to thirty minutes, at the end of which an adjustment of the air conditioning system and/or the lighting system is initiated so as to reduce consumption.

However, given the high action times and given the possible errors in detecting the user inside the room, the known solutions are not capable of efficiently reducing the energy consumed or, especially in cases of detection errors, they could lead to situations which are uncomfortable for the user in the room.

Furthermore, if the user were to quickly re-enter and exit the room, the countdown would restart, excessively prolonging the start of the adjustment of the air conditioning system.

### OBJECTS OF THE PRESENT INVENTION

The technical task of the present invention is thus to provide a method and a system for monitoring an environment which are capable of overcoming the drawbacks which have emerged from the prior art.

Therefore, the object of the present invention is to provide a method and a system for monitoring an environment which allow an efficient detection of the users presence so as to speed up the adjustment of the air conditioning system.

The specified technical task and the specified object are substantially achieved by a system and a method for monitoring an environment, comprising the technical features set forth in one or more of the appended claims. The dependent claims correspond to possible embodiments of the invention.

In particular, the specified technical task and the specified object are substantially achieved by a method for monitoring an environment comprising the steps of emitting, by means of wireless transmission, a presence code indicative of a user in the environment through a transmitter of the environment, intercepting the presence code by means of a user interface device, detecting an opening and subsequent closing event of an access door of the environment, and adjusting an environmental control system if, after the detected event, the presence code is not intercepted by the user interface device after a preset time interval.

Furthermore, the specified technical task and the specified object are substantially achieved by a system for monitoring an environment for carrying out the above-mentioned method, comprising a transmitter configured to emit a presence code, software installed or installable in a user interface device and configured to intercept said presence code, a detection device configured to detect an opening and closing event of an access door of the environment, an environmental control system and a control unit and at least one remote server configured to adjust the environmental control system if, after the detected event, the presence code is not intercepted by the user interface device after a preset time interval.

Advantageously, the present invention is capable of speeding up the adjustment of the air conditioning system so as to save energy more efficiently.

### BRIEF DESCRIPTION OF THE FIGURES

Further features and advantages of the present invention will become more apparent from the indicative and thus non-limiting description of an embodiment of a method and a system for monitoring an environment. Such a description will be set out below with reference to the accompanying drawings, which are provided solely for illustrative and therefore non-limiting purposes, in which:

FIG. 1 is a schematic representation of a system subject-matter of the present invention.

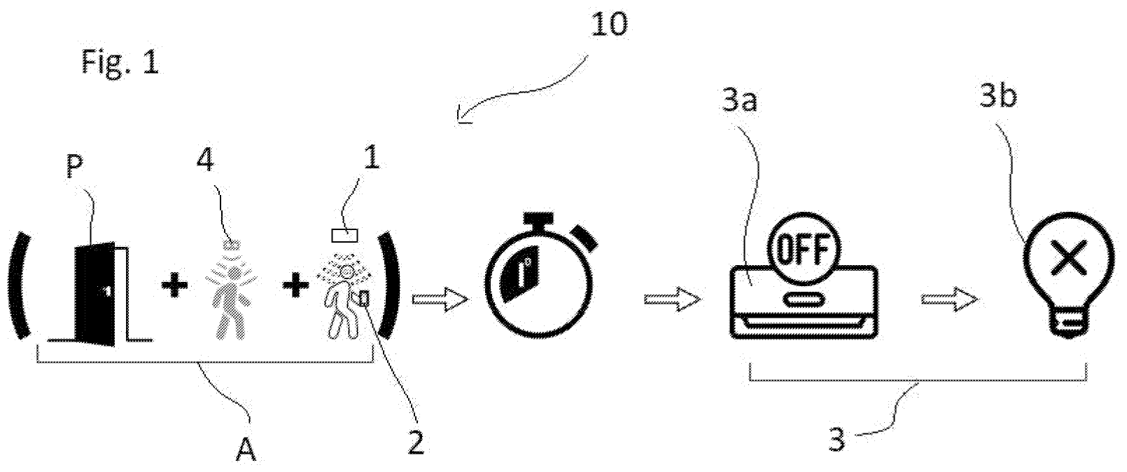

### DESCRIPTION OF ONE OR MORE PREFERRED, BUT NON-EXCLUSIVE, EMBODIMENTS OF THE PRESENT INVENTION

With reference to the appended figures, 10 denotes in its entirety a monitoring system subject-matter of the present invention.

The method for monitoring an environment subject-matter of the present invention is carried out or can be carried out in the aforesaid monitoring system 10.

The term environment “A” is intended as a room, a corridor, a common room, a garden and more in general any environment which is enclosed or in some way delimited by walls or fences.

The method includes emitting, by means of wireless transmission, a presence code indicative of a user in the environment “A”. The presence code is emitted through a transmitter 1 of the environment “A”. That is, the transmitter 1 is configured to emit wireless signals within the environment “A”.

The method further includes intercepting the presence code by means of a user interface 2. The term user interface device 2 is intended as a smartphone, a smartwatch, a token or other device (not necessarily provided with a screen) comprising the internal components necessary to intercept the wireless signals emitted by the transmitter 1.

The method further includes detecting an opening and subsequent closing event of an access door “P” of the environment “A”.

At this point, the method includes adjusting an environmental control system 3 after the detected event and if the presence code is not intercepted by the user interface device 2 after a preset time interval.

That is, from the moment in which the door “P” is opened and then closed and at the moment in which the user interface device 2 exits from the field of action of the transmitter 1, a countdown of the duration of the preset time interval is initiated.

Preferably, the preset time interval is reset if a further opening and subsequent closing event of the door “P” is detected.

Preferably, the preset time interval is reset if the presence code is again intercepted by means of the user interface device 2.

Preferably, the preset time interval is reset if both the above events (door opening and closing and presence code interception) occur.

For example, the preset time interval can be set to 10 minutes. Therefore, if the opening and closing event of the door “P” has not been detected for 10 minutes and the user interface device 2 is not in a range of action of the transmitter 1 which would allow the interception thereof, the adjustment of the environmental control system 3 would start.

The preset time interval can be set as a function of the different needs of those who manage the environment “A” or the environments “A” of interest.

Advantageously, such a solution allows to reduce the energy consumption by the environmental control system 3. It is thereby possible to reduce the environmental impact and the relative costs related to energy consumption.

For example, if the environment “A” is identified by a hotel room, the manager can decide to set the time interval from a few seconds to a few minutes so as to significantly reduce the costs related to energy consumption.

Preferably, the step of adjusting the environmental control system 3 includes adjusting an air conditioning system 3a and a lighting system 3b.

Preferably, the step of adjusting the environmental control system 3 comprises a first step of adjusting the air conditioning system 3a carried out after a first preset time interval and a second step of adjusting the lighting system 3b carried out after a second preset time interval subsequent to the first preset time interval.

The step of adjusting the air conditioning system 3a can be carried out by completely turning off the air conditioning system 3a or reducing the performance thereof (for example in winter, reducing the heating temperature of the environment “A” or in summer, raising the cooling temperature of the environment “A”).

Similarly, the step of adjusting the lighting system 3b can be carried out by completely turning off the lights or reducing an intensity thereof (also as a function of the time of day).

Similarly to the above, if the user were to re-enter the range of action of the transmitter 1 (i.e., the user interface device 2 intercepted the wireless signal emitted by the transmitter 1) after the adjustment step (both the first and the second adjustment step), the environmental control system would again operate “at full capacity” so that the environment “A” is already in the climatic and lighting conditions suitable for the needs of the user.

Preferably, the method further comprises a step of detecting a user by means of a detection system 4. Detection system 4 is intended as a motion sensor, a presence sensor, or devices configured to identify specific activities within the environment identifying a presence of the guest (such as turning on or off lights, the use of sockets or televisions or other devices inside the room and other similar activities), or any other similar means which can allow to know if the environment is occupied or not.

Therefore, the adjustment step is also carried out after the preset time interval if the detection system does not detect the user in the room.

Thereby, a third indicator can be used to ensure the certainty that the user is not in the environment “A” or in the immediate vicinity thereof so as to effectively adjust the environmental control system 3.

Advantageously, the method described above allows to obtain a reduced consumption in a fast and effective manner. Advantageously, the use of the transmitter 1 allows to identify when the user is in the immediate vicinity of the environment “A” so as to avoid unnecessary adjustments of the environmental control system 3 which could lead to a reduced enjoyment of the environment by the user.

Furthermore, the reduced energy consumption advantageously ensures a reduction in pollution and a reduction in energy costs.

The present invention further relates to a system 10 for monitoring the environment “A” for carrying out the method described above.

The monitoring system 10 comprises a transmitter 1 configured to emit, by means of wireless communication, the presence code.

The monitoring system 10 further comprises software installed or installable on the user interface device 2. The software (i.e., the user interface device 2) is configured to intercept the presence code emitted by the transmitter 1.

The monitoring system 10 further comprises a detection device (not shown) configured to detect an opening and closing event of an access door “P” of the environment “A”. Detection device can be understood as any sensor or other similar instrument which can detect the opening and subsequent closing of the door “P”.

The monitoring system 10 further comprises an environmental control system 3. The environmental control system 3 comprises an air conditioning system 3a and a lighting system 3b.

The monitoring system 10 further comprises a control unit and at least one remote server (not shown) configured to adjust the environmental control system 3 if, after the detected event, the presence code is not intercepted by the user interface device 2 after a preset time interval.

That is, the control unit and the remote server allow the different sub-steps of the method to be carried out. Therefore, the control unit and the remote server are configured to communicate with the transmitter 1, the user interface device 2 and to know whether the door “P” has been opened and closed so as to adjust the environmental control system 3 accordingly.

Preferably, the control unit and the remote server are configured to adjust the air conditioning system 3a after a first preset time interval and the lighting system 3b after a second preset time interval subsequent to the first preset time interval.

Preferably, the monitoring system 10 further comprising a detection system 4 for detecting the presence of the user in the environment “A”.

The detection system 4 can be obtained in the form of a motion sensor, a presence sensor, or devices configured to identify specific activities within the environment “A’ identifying a presence of the guest (such as turning on or off lights, the use of sockets or televisions or other devices inside the room and other similar activities), or any other similar means which can allow to know if the environment is occupied or not.

Advantageously, the present invention is capable of overcoming the drawbacks which have emerged from the prior art.

Advantageously, the present invention allows to carry out an efficient detection of the user's presence so as to speed up the adjustment of the environmental control system 3, reducing energy costs and reducing the environmental impact.

Furthermore, both in the embodiment in which only the transmitter 1 is present and in the embodiment in which the detection system 4 is present, the present invention is capable of adjusting the environmental control system 3 so as not to affect the user's enjoyment of the environment “A”.

1-12. (canceled)

13. A method for monitoring an environment, the method comprising:
emitting, by means of wireless transmission, a presence code indicative of a user in the environment through a transmitter of the environment;
intercepting said presence code by means of a user interface device;
detecting an opening and subsequent closing event of an access door of the environment;
adjusting an environmental control system if, after said detected event, said presence code is not intercepted by said user interface device after a preset time interval.

14. The method according to claim 13, wherein said preset time interval is reset if a further opening and subsequent closing event of the door is detected and/or said presence code is again intercepted by means of the user interface device.

15. The method according to claim 13, wherein said adjusting an environmental control system includes adjusting an air conditioning system and a lighting system.

16. The method according to claim 14, wherein said adjusting an environmental control system includes adjusting an air conditioning system and a lighting system.

17. The method according to claim 16, wherein said adjusting the environmental control system occurs with a first step of adjusting the air conditioning system carried out after a first preset time interval and a second step of adjusting the lighting system carried out after a second preset time interval subsequent to said first preset time interval.

18. The method according to claim 13, further comprising detecting a user by means of a detection system and wherein said adjustment step is further carried out after the preset time interval if said detection system does not detect said user in the environment.

19. A system for monitoring an environment for carrying out a method according to claim 13, the system comprising:
a transmitter configured to emit a presence code;
software installed or installable in a user interface device and configured to intercept said presence code;
a detection device configured to detect an opening and closing event of an access door of the environment;
an environmental control system,
a control unit and at least one remote server configured to adjust said environmental control system if, after said detected event, said presence code is not intercepted by said user interface device after a preset time interval.

20. The system according to claim 19, wherein said environmental control system comprises an air conditioning system and a lighting system.

21. The system according to claim 18, wherein said control unit and said at least one remote server are configured to adjust said air conditioning system after a first preset time interval and said lighting system after a second preset time interval subsequent to said first preset time interval.

22. The system according to claim 19, further comprising a detection system for detecting the presence of said user in the environment.

23. The system according to claim 20, further comprising a detection system for detecting the presence of said user in the environment.

24. The system according to claim 21, further comprising a detection system for detecting the presence of said user in the environment.
